(19) United States
(12) Patent Application Publication
(10) Pub. No.: US 2010/0134913 A1
(43) Pub. Date: Jun. 3, 2010

(54) FREQUENCY CONTROL APPARATUS AND STORAGE DEVICE

(75) Inventors: Tatsuhiko Kosugi, Kawasaki (JP); Takeyori Hara, Kawasaki (JP); Toru Ikeda, Kawasaki (JP); Susumu Yoshida, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/568,239

(22) Filed: Sep. 28, 2009

(30) Foreign Application Priority Data
Nov. 28, 2008 (JP) 2008-305655

(51) Int. Cl. G11B 5/09

(52) U.S. Cl. 360/51; G9B/5.033

(57) ABSTRACT

According to one embodiment, a frequency control apparatus includes an eccentric component storage module, a frequency correction amount calculating module, and an oscillator control module. The eccentric component storage module stores in advance an eccentric component calculated by a discrete Fourier transform of the number of clock signals measured for each servo frame. The frequency correction amount calculating module calculates the number of clock signals corresponding to the servo frame based on the eccentric component stored in the eccentric component storage module and calculates a frequency correction amount corresponding to the servo frame based on the number of clock signals. The oscillator control module controls the operation of a frequency oscillator such that a frequency for oscillating a clock signal in the frequency oscillator is adjusted according to the frequency correction amount calculated by the frequency correction amount calculating module.

### CROSS-REFERENCE TO RELATED APPLICATIONS

This application is based upon and claims the benefit of priority from Japanese Patent Application No. 2008-305655, filed Nov. 28, 2008, the entire contents of which are incorporated herein by reference.

### BACKGROUND

1. Field

One embodiment of the invention relates to a frequency control apparatus that performs frequency control using a disk synchronous write (DSW) method and a storage device.

2. Description of the Related Art

Storage devices, such as hard disk drives, have been used that read/write user data from/to a disk-shape storage medium (see, for example, Japanese Patent Application Publication (KOKAI) No. 2008-34067). The storage device alternately performs detection of servo frames written to the storage medium at equivalent intervals and data access to a data area between the servo frames. For this reason, format efficiency can be improved by reducing the time to open a servo gate to detect the servo frames, and increasing the time to perform data access.

Meanwhile, when the storage device is manufactured, a shift (eccentricity) maybe generated between the center of the storage medium and the center of spindle rotation of the storage medium. In the storage device, a variation is generated in the length of the data area between the servo frames, and the time required from detection of a servo frame to detection of the next servo frame adjacent to the servo frame varies. For this reason, as compared to a storage device where the lengths of the servo frames are uniform, the time in which the servo gate is opened needs to be increased, and format efficiency is lowered. As a technology for suppressing the format efficiency from being lowered due to eccentricity in the storage device, a disk synchronous write (DSW) method is used.

The operation of a storage device using the DSW method will be described. The storage device using the DSW method controls the operation of a frequency oscillator such that a fixed number of clock signals are oscillated during data access, even when a variation is generated in the time length of data access to each data area. In addition, the storage device using the DSW method opens a servo gate after detecting a servo frame and counting a fixed number of clock signals.

In the storage device using the DSW method, each time a servo frame is detected, a frequency correction amount needs to be calculated based on the number of clock signals measured upon detection of the servo frame to instruct a frequency oscillator on it. For this reason, when a detection error of a servo frame occurs, the frequency correction amount may not be calculated. As a result, a frequency instruction may not be issued to the frequency oscillator. To cope with the detection error of a servo frame, Japanese Patent Application Publication (KOKAI) No. 2006-252731 discloses a conventional technology in which, when a detection error of a servo frame occurs, a frequency correction amount is calculated by performing a linear interpolation.

With the conventional technology, when a detection error of a servo frame occurs, the linear interpolation is required. This increases the processing load for calculating the frequency correction amount.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram for explaining the outline of a disk device according to a first embodiment of the invention;

FIG. 2 is an exemplary block diagram of the disk device in the first embodiment;

FIG. 3 is an exemplary schematic diagram of a storage medium in the first embodiment;

FIG. 4 is an exemplary schematic diagram for explaining the operation of a discrete Fourier transforming module and an addition learning module in the first embodiment;

FIG. 5 is an exemplary schematic diagram for explaining the operation of an eccentric component acquiring module in the first embodiment;

FIG. 6 is an exemplary flowchart of the operation of the disk device in the first embodiment;

FIG. 7 is another exemplary flowchart of the operation of the disk device in the first embodiment;

FIG. 8 is an exemplary block diagram of a disk device according to a second embodiment of the invention;

FIG. 9 is an exemplary schematic diagram for explaining the operation of a servo CPU in the second embodiment;

FIG. 10 is an exemplary chart for explaining a disk device according to a third embodiment of the invention; and

FIG. 11 is another exemplary chart for explaining the disk device in the third embodiment.

### DETAILED DESCRIPTION

Various embodiments according to the invention will be described hereinafter with reference to the accompanying drawings. In general, according to one embodiment of the invention, a frequency control apparatus comprises an eccentric component storage module, a frequency correction amount calculating module, and an oscillator control module. The eccentric component storage module is configured to store in advance an eccentric component calculated by a discrete Fourier transform of the number of clock signals measured for each servo frame. The frequency correction amount calculating module is configured to calculate the number of clock signals corresponding to the servo frame based on the eccentric component stored in the eccentric component storage module and calculate a frequency correction amount corresponding to the servo frame based on the number of clock signals. The oscillator control module is configured to control the operation of a frequency oscillator such that a frequency for oscillating a clock signal in the frequency oscillator is adjusted according to the frequency correction amount calculated by the frequency correction amount calculating module.

According to another embodiment of the invention, a storage device comprises an eccentric component storage module, a frequency correction amount calculating module, and an oscillator control module. The eccentric component storage module is configured to store in advance an eccentric component calculated by a discrete Fourier transform of the number of clock signals measured for each servo frame. The frequency correction amount calculating module is configured to calculate the number of clock signals corresponding to the servo frame based on the eccentric component stored in the eccentric component storage module and calculate a frequency correction amount corresponding to the servo frame based on the number of clock signals. The oscillator control module is configured to control the operation of a frequency oscillator such that a frequency for oscillating a clock signal in the frequency oscillator is adjusted according to the frequency correction amount calculated by the frequency correction amount calculating module.

The term “servo frame” as used herein refers to information that is written at equivalent intervals to draw concentric circles with the center of a storage medium as the center. The term “servo number” as used herein refers to a number (for example, SF0 to SF7) that is given to each servo frame. The term “servo frame time” as used herein refers to the length of a time required from a predetermined servo frame is detected until a next servo frame adjacent to the predetermined servo frame is detected.

The term “ideal frequency” as used herein refers to a frequency that is set in advance in a frequency oscillator. The term “frequency correction amount” as used herein refers to a numerical value set to the frequency oscillator so that a fixed number of clock signals are oscillated between servo frame times. The term “reference value” as used herein refers to the number of clock signals to be oscillated by the frequency oscillator for each servo frame time.

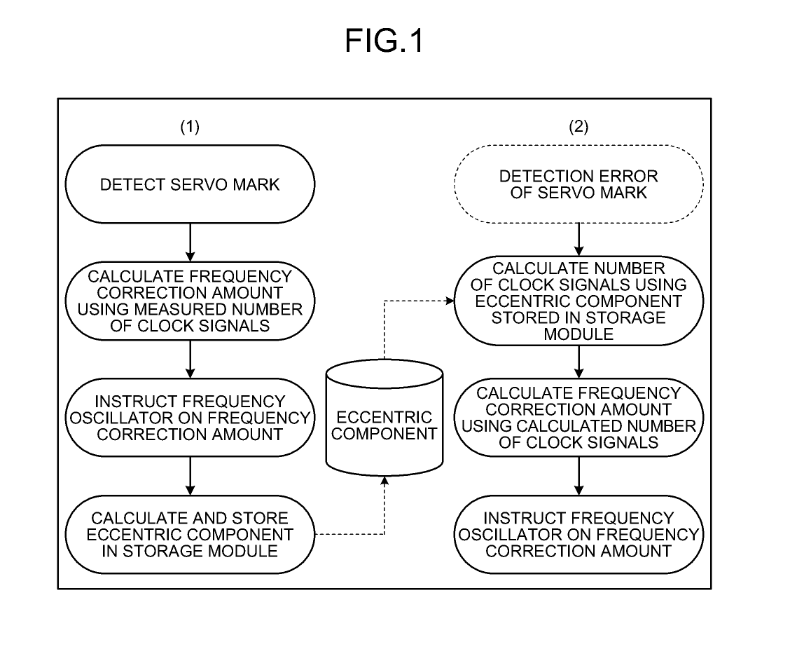

FIG. 1 is a schematic diagram for explaining the outline of a disk device according to a first embodiment of the invention. The disk device of the first embodiment calculates a frequency correction amount based on the number of clock signals measured for each servo frame, and controls the operation of a frequency oscillator to oscillate a clock signal based on the calculated frequency correction amount. Even when a detection error of a servo frame occurs, the disk device of the first embodiment calculates the frequency correction amount with less processing load.

When a servo frame is detected, as illustrated in (1) of FIG. 1, the disk device of the first embodiment calculates a frequency correction amount based on the number of clock signals measured at the time of detecting a servo frame, instructs the frequency oscillator on the calculated frequency correction amount, and controls the operation of the frequency oscillator. In addition, the disk device of the first embodiment performs a discrete Fourier transform of the number of clock signals measured for each servo frame to calculate an eccentric component, and stores the calculated eccentric component in a storage module. The eccentric component is a numerical value that indicates the magnitude of expansion and contraction of each data area between the servo frames.

When a servo frame is not detected, as illustrated in (2) of FIG. 1, the disk device of the first embodiment calculates the number of clock signals corresponding to the non-detected servo frame based on the eccentric component stored in the storage module. The calculated number of clock signals indicates the magnitude of expansion and contraction of a data area subsequent to the non-detected servo frame.

Then, the disk device of the first embodiment calculates a frequency correction amount corresponding to the non-detected servo frame based on the calculated number of clock signals. In addition, the disk device of the first embodiment controls the operation of the frequency oscillator such that a frequency used for oscillating a clock signal in the frequency oscillator is adjusted according to the calculated frequency correction amount.

In this way, even when a detection error of a servo frame occurs, the disk device of the first embodiment can easily calculate a frequency correction amount based on the eccentric component stored in advance in the storage module.

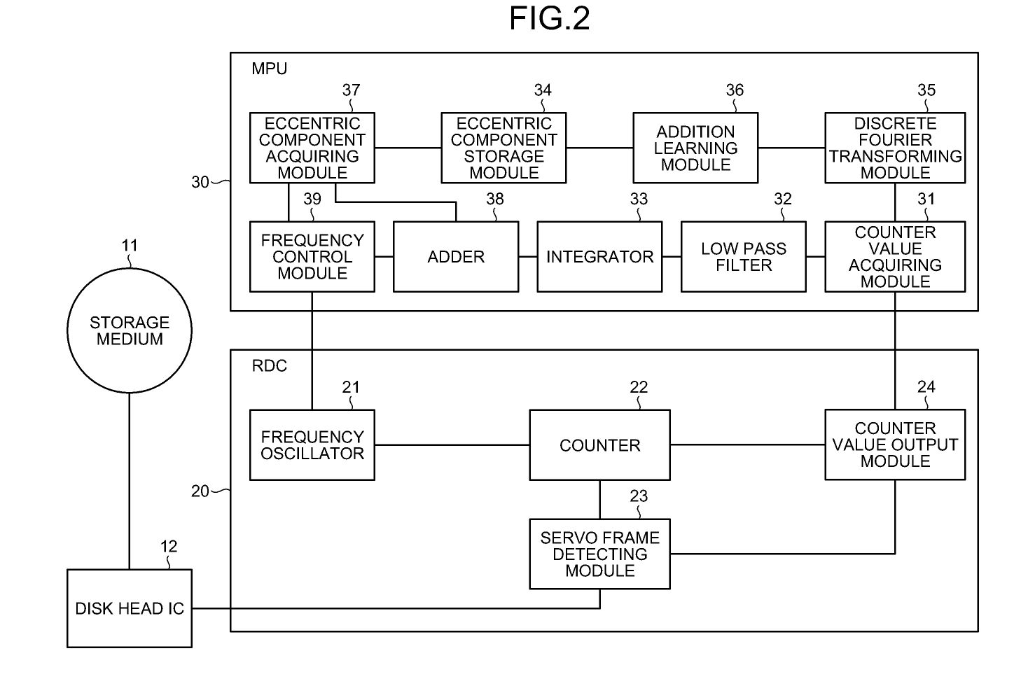

FIG. 2 is a block diagram of a disk device 10. As illustrated in FIG. 2, the disk device 10 comprises a storage medium 11, a disk head integrated circuit (IC) 12, a read channel (RDC) 20, and a micro processing unit (MPU) 30.

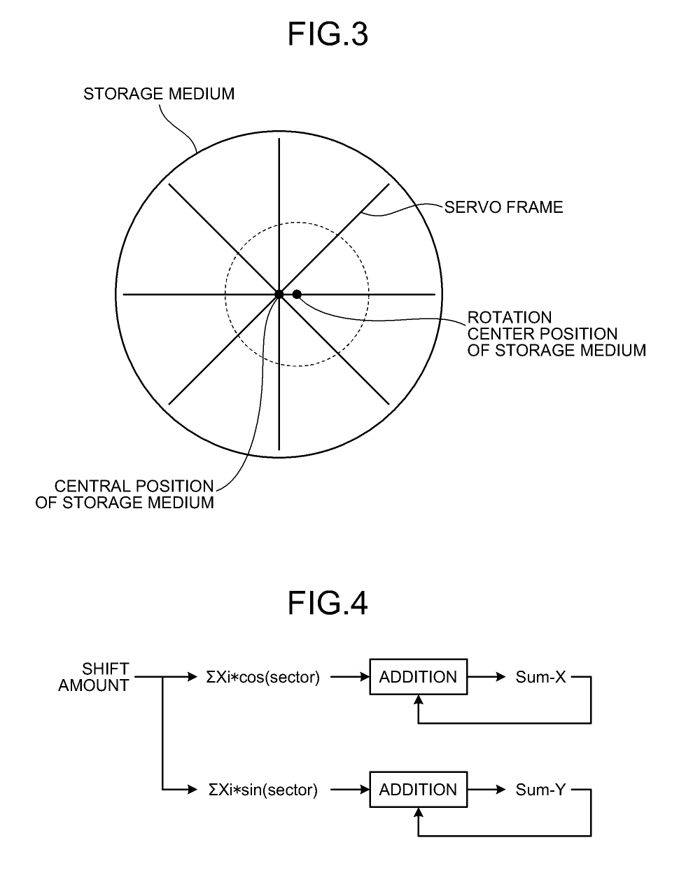

FIG. 3 illustrates an example of the storage medium 11. The storage medium 11 comprises a plurality of servo frames arranged at equivalent intervals to draw a concentric circle with the center of the storage medium 11 as the center. In addition, the storage medium 11 has data areas between the servo frames. A shift (eccentricity) is generated between the center of the storage medium 11 and the center of spindle rotation of the storage medium 11. As illustrated in FIG. 3, a variation is generated in the length of each data area.

The disk head IC 12 detects a servo mark on the storage medium 11, and reads/writes user data.

The RDC 20 comprises a frequency oscillator 21, a counter 22, a servo frame detecting module 23, and a counter value output module 24. The frequency oscillator may be located outside the RDC.

The frequency oscillator 21 oscillates a clock signal. Specifically, the frequency oscillator 21 has a 16-bit register that stores a frequency correction amount. The frequency oscillator 21 corrects an ideal frequency based on the frequency correction amount stored in the register, and outputs a clock signal oscillated with a frequency after the correction to the counter 22.

The counter 22 measures the number of clock signals oscillated by the frequency oscillator 21. Specifically, the counter 22 adds a counter value indicating the total number of clock signals oscillated by the frequency oscillator 21 each time a clock signal is received from the frequency oscillator 21, and measures the number of clock signals oscillated by the frequency oscillator 21. Hereinafter, the number of clock signals will be referred to as the counter value.

The servo frame detecting module 23 outputs a servo frame detection signal to the counter value output module 24 each time the disk head IC 12 detects a servo frame.

The counter value output module 24 outputs a counter value (for example, 100, 110, 121, . . . ) measured by the counter 22 to the MPU 30 on each receipt of a servo frame detection signal from the servo frame detecting module 23.

The MPU 30 comprises a counter value acquiring module 31, a low pass filter 32, an integrator 33, an eccentric component storage module 34, a discrete Fourier transforming module 35, an addition learning module 36, an eccentric component acquiring module 37, an adder 38, and a frequency control module 39.

Upon receipt of a counter value from the counter value output module 24, the counter value acquiring module 31 calculates a differential counter value (for example, 10, 11, 9, . . .) between the counter value and a counter value received last time. In addition, the counter value acquiring module 31 calculates a shift value (for example, 0, 1, −1, . . . ), which is a difference between the differential counter value and a referenced value (for example, 10). The differential counter value corresponds to the number of clock signals oscillated by the frequency oscillator 21 between the individual servo frame times. As the time has elapsed, the differential counter value is converged to the reference value, and the shift amount is converged to 0.

The low pass filter 32 removes a high frequency component from the shift amount calculated by the counter value acquiring module 31. The integrator 33 performs an integrating process on the shift amount after the high frequency component is removed by the low pass filter 32 and calculates a DC component. The DC component is a counter value that corresponds to a rotational variation amount of a motor rotating the storage medium 11. For example, if the number of revolutions of the motor per unit time becomes smaller than the target number, the DC component becomes 0 or more. If the number of revolutions of the motor per unit time becomes larger than the target number, the DC component becomes 0 or less.

The eccentric component storage module 34 previously stores an eccentric component calculated by a discrete Fourier transform of the number of clock signals measured for each servo frame. Specifically, the eccentric component storage module 34 stores a sine component (Sum−X) of an eccentric component and a cosine component (Sum−Y) of the eccentric component.

FIG. 4 is a schematic diagram for explaining the operation of the discrete Fourier transforming module 35 and the addition learning module 36. The discrete Fourier transforming module 35 performs a discrete Fourier transform of the number of clock signals measured for each servo frame and calculates an eccentric component. The addition learning module 36 adds the eccentric component calculated by the discrete Fourier transforming module 35 and the eccentric component stored in the eccentric component storage module 34 and learns the eccentric component.

Specifically, as illustrated in FIG. 4, if the storage medium rotates once, the discrete Fourier transforming module 35 acquires a shift amount (Xi) corresponding to each servo frame from the counter value acquiring module 31. Subsequently, the discrete Fourier transforming module 35 performs a discrete Fourier transform on the acquired shift amount, and calculates a sine component (ΣXi*sin(sector)) of an eccentric component and a cosine component (ΣXi*cos(sector)) of the eccentric component. Here, “*” indicates integration. The calculated eccentric component is a component used to correct the eccentric component calculated when the storage medium rotates once.

The addition learning module 36 adds the sine component of the eccentric component calculated by the discrete Fourier transforming module 35 and the sine component of the eccentric component stored in the eccentric component storage module 34, and updates the sine component of the eccentric component stored in the eccentric component storage module 34. In addition, the addition learning module 36 adds the cosine component of the eccentric component calculated by the discrete Fourier transforming module 35 and the cosine component of the eccentric component stored in the eccentric component storage module 34, and updates the cosine component of the eccentric component stored in the eccentric component storage module 34. As the time has elapsed, the sine component (Sum−Y) of the eccentric component and the cosine component (Sum−X) of the eccentric component are converged to predetermined values.

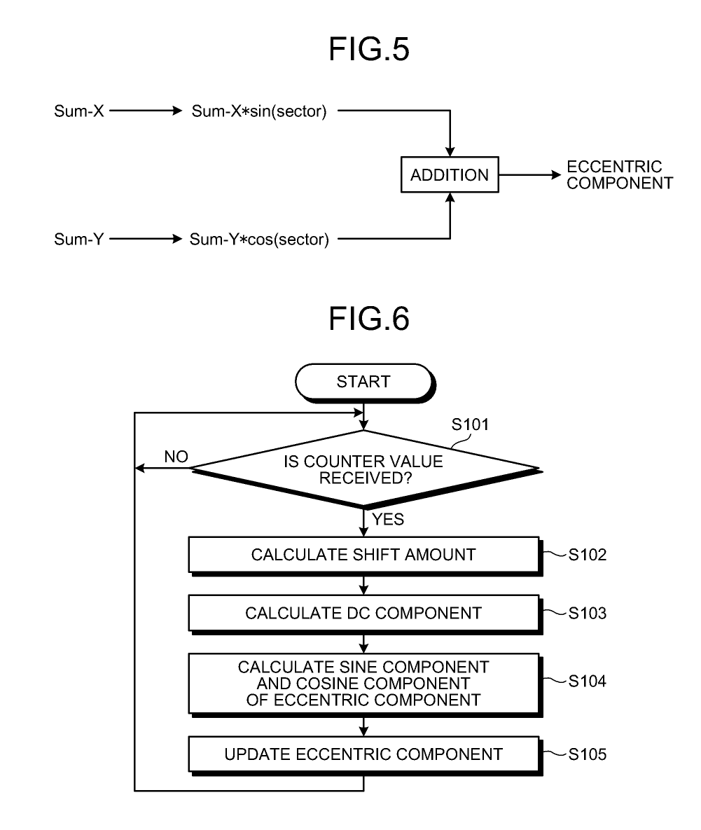

FIG. 5 is a schematic diagram for explaining the operation of the eccentric component acquiring module 37. The eccentric component acquiring module 37 functions as a frequency correction amount calculating module. When a servo frame is not detected, the eccentric component acquiring module 37 calculates the number of clock signals corresponding to the non-detected servo frame based on the eccentric component stored in the eccentric component storage module 34.

Specifically, as illustrated in FIG. 5, the eccentric component acquiring module 37 calculates a counter value corresponding to the non-detected servo frame based on the eccentric component stored in the eccentric component storage module 34. The term “sector” indicates the magnitude of an elevation angle between a servo frame corresponding to an index (SF0) and the non-detected servo frame.

The calculated counter value is a counter value corresponding to expansion (contraction) of a data area subsequent to the non-detected servo frame. For example, when the expansion is generated in the data area subsequent to the non-detected servo frame, the calculated counter value becomes 0 or more. When the contraction is generated in the data area subsequent to the non-detected servo frame, the calculated counter value becomes 0 or less.

The adder 38 adds a DC component calculated by the integrator 33 and a counter value calculated by the eccentric component acquiring module 37. The frequency control module 39 functions as an oscillator control module. The frequency control module 39 calculates a frequency correction amount corresponding to the non-detected servo frame based on the component calculated by the adder 38. In addition, the frequency control module 39 controls the operation of the frequency oscillator 21 such that a frequency used for oscillating a clock signal in the frequency oscillator 21 is adjusted according to the calculated frequency correction amount.

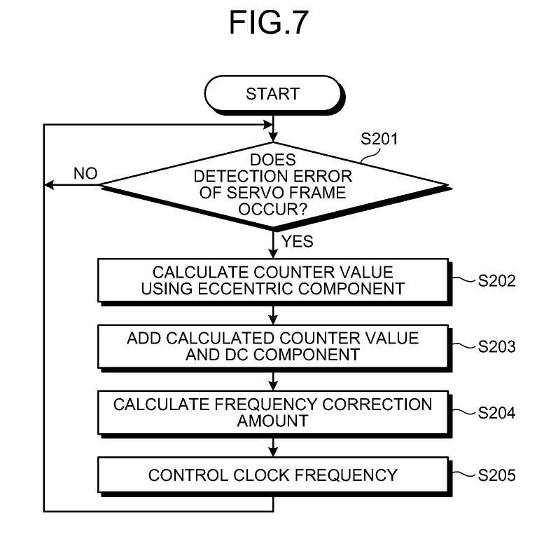

FIGS. 6 and 7 are flowcharts of the operation of the disk device 10 of the first embodiment. First, with reference to FIG. 6, a description will be given of the operation of the MPU 30 from the counter value is received until the eccentric component stored in the eccentric component storage module 34 is updated. As illustrated in FIG. 6, if receiving a counter value from the counter value output module 24 (Yes at S101), the counter value acquiring module 31 calculates a shift amount (S102). Next, the low pass filter 32 removes a high frequency component from the shift amount, and the integrator 33 performs an integrating process on the shift amount after the high frequency component is removed, and calculates a DC component (S103).

Next, the discrete Fourier transforming module 35 performs a Fourier transformation on a shift amount corresponding to each servo frame, and calculates a sine component of an eccentric component and a cosine component of the eccentric component (S104). Thereafter, the addition learning module 36 adds each calculated eccentric component and the eccentric component stored in the eccentric component storage module 34, and updates the eccentric component (S105). The counter value acquiring module 31 maintains a waiting state until the counter value is received (S101).

With reference to FIG. 7, a description will then be given of the operation of the MPU 30 from a detection error of a servo frame occurs until the frequency of the clock signal oscillated by the frequency oscillator 21 is controlled. As illustrated in FIG. 7, if a detection error of a servo frame occurs (Yes at S201), the eccentric component acquiring module 37 calculates a counter value corresponding to the non-detected servo frame based on the eccentric component stored in the eccentric component storage module 34 (S202).

Next, the adder 38 adds the DC component calculated by the integrator 33 and the counter value calculated by the eccentric component acquiring module 37 (S203). The frequency control module 39 calculates a frequency correction amount corresponding to the non-detected servo frame (S204). Then, the frequency control module 39 instructs the frequency oscillator 21 on the calculated frequency correction amount, and controls the frequency of the clock signal oscillated by the frequency oscillator 21 (S205).

As described above, according to the first embodiment, even when a detection error of a servo frame occurs, the frequency correction amount can be calculated with less processing load.

In the first embodiment, the discrete Fourier transforming module 35 may determine whether each shift amount is in a predetermined allowable range, and perform a discrete Fourier transform on the shift amount only when each shift amount is in the predetermined allowable range. In this way, if the servo frames are detected while being skipped one by one, an appropriate eccentric component may be maintained.

In the first embodiment, only when a detection error of a servo frame occurs, the frequency of the clock signal oscillated by the frequency oscillator 21 is controlled based on the eccentric component stored in the eccentric component storage module 34. However, it is not so limited, and the frequency of the clock signal oscillated by the frequency oscillator 21 may always be controlled based on the eccentric component stored in the eccentric component storage module 34.

In a storage medium that has data areas at both sides thereof or a disk device that has a plurality of storage media, head change operation of changing a disk head performing data access is performed. When the head change operation is performed, a skew time, which is a time interval from immediately before detection of a servo frame to first detection of a servo frame after the head change is performed, needs to be calculated in advance. A disk device that calculates a skew time based on an eccentric component will be described in a second embodiment of the invention.

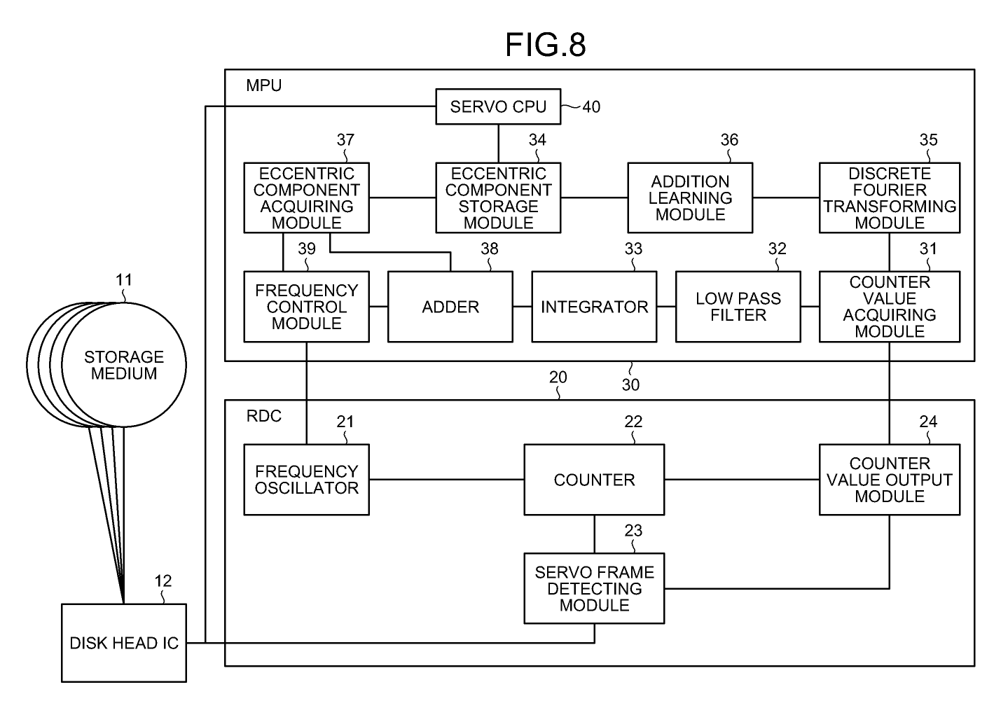

FIG. 8 is a block diagram of the disk device 10 according to the second embodiment. As illustrated in FIG. 8, the disk device 10 of the second embodiment further comprises a servo CPU 40 in addition to the constituent elements of the disk device 10 of the first embodiment. The difference between the disk device 10 of the second embodiment and that of the first embodiment will be described.

The eccentric component storage module 34 stores an eccentric component with respect to each disk head. The eccentric component is updated by the discrete Fourier transforming module 35 and the addition learning module 36 during data access through the corresponding disk head.

The servo CPU 40 functions as a head change control module. The servo CPU 40 transmits a predetermined head number to the disk head IC 12, and changes the disk head performing data access. In addition, the servo CPU 40 calculates a skew time and controls the RDC 20 to open a servo gate before an elapsed time from immediately before detection of a servo frame reaches the skew time.

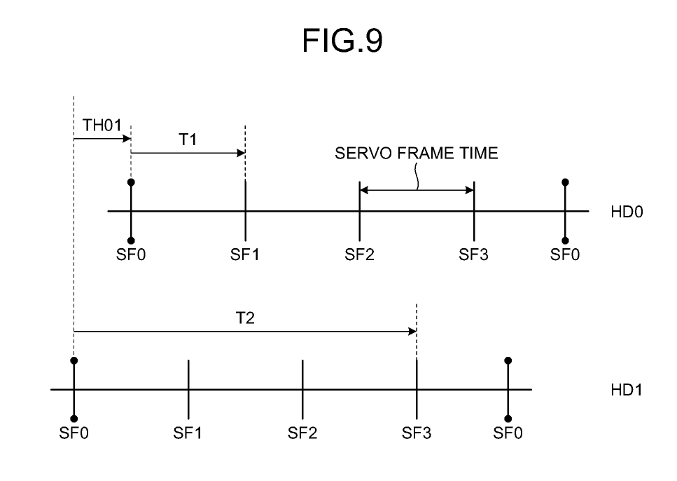

FIG. 9 is a schematic diagram for explaining the operation of the servo CPU 40. With reference to FIG. 9, a description will be given of the operation of the servo CPU 40 in the case of calculating a skew time from when a servo frame corresponding to a servo number (SF1) is detected by a disk head corresponding to a head number (HD0) to when a servo frame corresponding to a servo frame (SF3) is detected by a disk head corresponding to a head number (HD1).

The servo CPU 40 acquires an eccentric component corresponding to the head number (HD0) from the eccentric component storage module 34, and calculates a counter value corresponding to a servo frame (SF0) based on the acquired eccentric component. Subsequently, the servo CPU 40 calculates a time (“T1” in FIG. 9) required from detection of the servo frame (SF0) to detection of the servo frame (SF1) based on the calculated counter value and a reference value.

The servo CPU 40 acquires an eccentric component corresponding to the head number (HD1) from the eccentric component storage module 34, and calculates counter values corresponding to servo frames (SF0, SF1, and SF2) based on the acquired eccentric component. Subsequently, the servo CPU 40 calculates a time required from detection of a servo frame to detection of the next servo frame based on the calculated counter values and the reference value, and calculates a time (“T2” in FIG. 9) required from detection of the servo frame (SF0) to detection of the servo frame (SF3).

In addition, the servo CPU 40 calculates a skew time using an offset time (“TH01” in FIG. 9) between the head numbers (HD0 and HD1), and the times “T1” and “T2”.

As described above, according to the second embodiment, since the skew time can be easily calculated based on the eccentric component, the processing load on the head change operation can be reduced. Further, according to the second embodiment, the head change operation can be realized without creating a dedicated table to calculate the skew time.

A third embodiment of the invention will be described. A relationship between a frequency (F) of a clock signal oscillated by the frequency oscillator and a servo frame time (T) is represented as “T=1/F”. If it is assumed that a differential frequency between the clock frequency oscillated by the frequency oscillator and the ideal frequency is minute (for example, about 0.5%) with respect to the ideal frequency, “T (1+Δ)=1/{F (1+Δ)}≈(1−Δ)/F” is formed.

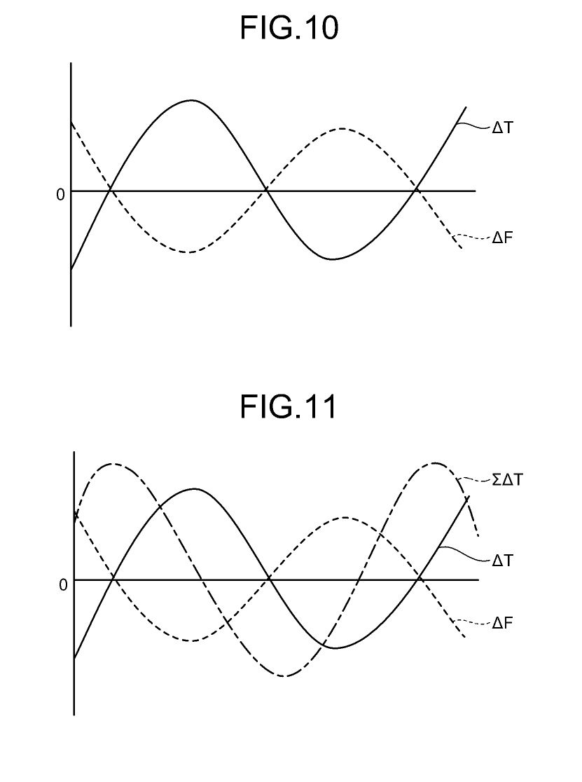

That is, as illustrated in FIG. 10, the frequency correction amount (ΔF) and the magnitude (ΔT) of expansion and contraction of the servo frame time follow a relationship where phases are different by 180° . One cycle of a sine wave that indicates the frequency correction amount corresponds to one rotation of the storage medium.

The magnitude (ΣΔT) of expansion and contraction in T1 or T2 corresponds to the integration of ΔT. Since ΔT has a sinusoidal shape, in the magnitude (ΣΔT) of expansion and contraction in T1 or T2, a phase is shifted by 90 degrees with respect to ΔT. As a result, a phase relationship between ΔF, ΔT, and ΣΔT is as illustrated in FIG. 11. With this property, the skew time can be calculated at a time.

That is, the servo CPU 40 calculates the skew time using Equation as follows:

α*Sum-X*sin(sector+π/2)+α*Sum−Y*cos(sector+π/2)

where α is an integral coefficient for converting an eccentric component into an area. The “sector” corresponds to the magnitude of an elevation angle between a servo frame corresponding to an index (SF0) and the predetermined servo frame (for example, when T2 is calculated, the sector corresponds to the magnitude of an elevation angle between the servo frame corresponding to the index (SF0) and the servo frame corresponding to the index (SF3)).

According to the third embodiment, the skew time can be calculated without division, resulting in less calculation time. Moreover, calculation precision may be maintained.

While specific embodiments have been described, other embodiments or modifications are also possible. In the following, such modifications will be described

The constituent elements of the disk device 10 illustrated in FIG. 2 or 8 are functionally conceptual, and need not be physically configured as illustrated. In other words, the specific mode of dispersion and integration of the constituent elements is not limited to the ones illustrated in FIG. 2 or 8, and the constituent elements, as a whole or in part, can be divided or integrated in arbitrary units either functionally or physically based on various types of loads or use conditions. For example, the disk heads corresponding to the front and rear sides of the storage medium 11 may be provided.

All or any part of the processing functions performed by the disk device 10 may be realized by a central processing unit (CPU) and a program analyzed and executed by the CPU, or may be realized as hardware by wired logic.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A frequency control apparatus comprising:
an eccentric component storage module configured to store in advance an eccentric component calculated by a discrete Fourier transform of number of clock signals measured for each servo frame;
a frequency correction amount calculating module configured to calculate the number of clock signals corresponding to the servo frame based on the eccentric component stored in the eccentric component storage module and calculate a frequency correction amount corresponding to the servo frame based on the number of clock signals; and
an oscillator control module configured to control operation of a frequency oscillator such that a frequency for oscillating a clock signal in the frequency oscillator is adjusted according to the frequency correction amount calculated by the frequency correction amount calculating module.

2. The frequency control apparatus of claim 1, further comprising a head change control module configured to calculate a skew time based on the eccentric component stored in the eccentric component storage module, and perform head change based on the skew time, the skew time being a time interval from immediately before detection of a servo frame to first detection of a servo frame after the head change.

3. The frequency control apparatus of claim 2, wherein the head change control module is configured to calculate the skew time based on the eccentric component stored in the eccentric component storage module and an integral coefficient for converting the eccentric component to an area, and perform the head change based on the skew time.

4. The frequency control apparatus of claim 1, further comprising an eccentric component calculating module configured to determine, each time the number of clock signals is measured, whether the number of clock signals is in a predetermined allowable range, and perform a discrete Fourier transform of the number of clock signals determined to be in the predetermined allowable range to calculate the eccentric component.

5. A storage device comprising:
an eccentric component storage module configured to store in advance an eccentric component calculated by a discrete Fourier transform of number of clock signals measured for each servo frame;
a frequency correction amount calculating module configured to calculate the number of clock signals corresponding to the servo frame based on the eccentric component stored in the eccentric component storage module and calculate a frequency correction amount corresponding to the servo frame based on the number of clock signals; and
an oscillator control module configured to control operation of a frequency oscillator such that a frequency for oscillating a clock signal in the frequency oscillator is adjusted according to the frequency correction amount calculated by the frequency correction amount calculating module.
